(19) United States
(12) Patent Application Publication
(10) Pub. No.: US 2023/0060245 A1
(43) Pub. Date: Mar. 2, 2023

(54) SYSTEM AND METHOD FOR AUTOMATED ACCOUNT PROFILE SCORING ON CUSTOMER RELATIONSHIP MANAGEMENT PLATFORMS

(71) Applicant: Account Spark, Inc., San Francisco, CA (US)

(72) Inventor: Noor Nader Atari, San Francisco (US)

(21) Appl. No.: 17/410,391

(22) Filed: Aug. 24, 2021

(51) Int. Cl. G06Q 30/02; G06Q 30/00

(52) U.S. Cl. CPC G06Q 30/0201; G06Q 30/01

(57) ABSTRACT

A system and method for scoring contract entities is disclosed. The system obtains past performance data associated to an account comprising historical data associated with the account for a predefined time period and determines a data field associated with the contract entity. The system may further retrieve customer management data associated with the contract entity and detect a purchasing behavior associated with the account. Further, the system may determine a cohort comprising a subset of contract entities grouped therein, wherein the contract entity is grouped in the cohort based on the purchasing behavior. The system may then calculate, based at least on the grouping of the contract entity in the cohort, an impact score, and a prospect score for the contract entity.

### CROSS-REFERENCE TO RELATED APPLICATIONS

None.

### BACKGROUND OF THE INVENTION

### Field of the Art

The disclosure relates to the field of automated customer relationship management, and more particularly to the field of entity scoring.

Discussion of the State of the Art

The current competitive ecosystem comprises of mostly homegrown solutions in which relatively large, generally high-tech companies, leverage internally hired data science resources to produce internal entity scoring models. These homegrown solutions are not for commercial use and are specific only to the particular organization that has authored them. A few enterprises have adjacent solutions to entity scoring in the marketplace including Lattice™, Mattermark™, D&B Buyer Intent™, and Anaplan Mintigo™.

Note that the identified novelties differentiate the present invention from the rest of the marketplace (e.g., some companies offer propensity to buy probabilities but not a prediction on potential quantification of deal size). It is important to distinguish entity scoring from other similar analytical scoring solutions such as lead or opportunity scoring (for reference, leads are individuals who have expressed interest in purchasing; opportunities are deals that are in progress, oftentimes having been converted from a lead; and accounts are any company whether an existing customer or a prospect where a user can create an opportunity and attach it to an account).

For most sales and marketing teams, there are more companies available globally than one can possibly pursue, so these professionals are challenged on focusing their limited time wisely.

A need arises for entity scoring comprising, at least, a quantified potential revenue and a calculated probability of positive result using analytical insights for ordering and prioritizing accounts to quantify a likelihood to yield greater business.

### SUMMARY OF THE INVENTION

Accordingly, the inventor has conceived and reduced to practice, in a preferred embodiment of the invention, systems and methods for analyzing a plurality of customer relationship management (CRM) contract entities and producing quantified predictions of which contract entities are most likely to yield a maximum contract entity score for each user device. The system may be operable to perform advanced statistical analyses, including cohort studies, binomial regression for predicting expansion and diversification actions, and reinforced machine learning for incorporating user feedback. The system may further be operable to capture changes in the data associated with contract entities and refresh quantified predictions continuously. Furthermore, the system may provide a planning hub for user devices that may include an opportunity matrix of quadrants, each recognizing varying action strategies for one or more contract entities under processing. The system advantageously produces a contract entity scoring mechanism that may synchronize a large number of records in a small span of time, thereby arming user devices with actionable, live, and dynamic insights. Also, the present invention may aid user devices to focus resources on the high-value contract entities and prospects to realize increasing productivity and attainment of threshold targets.

According to a preferred embodiment of the invention, a system for generating cores for a plurality of contract entities is disclosed. The system may comprise a network-connected entity scoring computer comprising a memory, a processor, and a plurality of programming instructions, the plurality of programming instructions when executed by the processor cause the processor to obtain, from a database, past performance data associated to an contract entity from the plurality of contract entities associated with a user device, of a plurality of user devices, wherein the past performance data at least comprises historical data associated with the contract entity for a predefined time period; determine at least one firmographic data field, from a plurality of firmographic data fields, associated with the contract entity; retrieve, from the database, customer management data associated with the contract entity; detect, based on the firmographic data field, the customer management data, and the past performance data associated with the contract entity, a purchasing behavior associated with the contract entity; determine, a cohort comprising a subset of contract entities from the plurality of contract entities grouped therein, wherein the contract entity is grouped in the cohort based on the purchasing behavior detected for the contract entity; calculate, based at least on the grouping of the contract entity in the cohort, an impact score and a prospect score for the contract entity.

According to another embodiment of the invention, the programming instructions, when further executed by the processor, cause the processor to determine the at least one firmographic data field from the plurality of firmographic data fields comprising commerce sector, geolocation, and market segment.

According to another embodiment of the invention, the programming instructions, when further executed by the processor, cause the processor to obtain feedback from the plurality of user devices, wherein the feedback is associated with an original impact score for the contract entity; create, based on the obtained feedback, whether the original impact score for the contract entity is marked as accurate a neural network model.

According to another embodiment of the invention, the programming instructions, when further executed by the processor, cause the processor to determine, based on the obtained feedback, whether the original impact score for the contract entity is marked as accurate by the predefined percentage of user devices from the plurality of user devices; determine, in response to a determination that the original impact score is marked as inaccurate, whether the current impact score is greater than the original impact score and the original impact score is lower than a first threshold; and associate the current impact score with the contract entity, in response to a determination that the current impact score is greater than the original impact score and the original impact score is lower than the first threshold.

According to another embodiment of the invention, the programming instructions, when further executed by the processor, cause the processor to add a second threshold to the original impact score in response to a determination that the current impact score is not greater than the original impact score; and associate the original impact score with the contract entity.

According to another embodiment of the invention, the programming instructions, when further executed by the processor, cause the processor to determine, in response to the determination that the original impact score is marked as inaccurate, whether the current impact score is lower than the original impact score and the original impact score is greater than the first threshold; and associate the current impact score with the contract entity, in response to a determination that the current impact score is lower than the original impact score and the original impact score is greater than the first threshold.

According to another embodiment of the invention, the programming instructions, when further executed by the processor, cause the processor to subtract the second threshold from the original impact score in response to a determination that the current impact score is not lower than the original impact score; and associate the original impact score with the contract entity.

According to another embodiment of the invention, the programming instructions, when further executed by the processor, cause the processor to associate the original impact score with the contract entity in response to a determination that the original impact score is not greater than the first threshold.

According to another embodiment of the invention, the programming instructions, when further executed by the processor, cause the processor to generate a ranking of the contract entity based on the contract entity score; determine a quadrant, within a contract entity matrix, for the contract entity based on a comparison of the generated ranking for the contract entity to a predefined percentile threshold; position the contract entity in the determined quadrant.

In a preferred embodiment of the invention, a computer-implemented method for computing a score for a contract entity from a plurality of contract entities is disclosed. The method may comprise obtaining, from a database by a network-connected entity scoring computer, past performance data associated to an contract entity from the plurality of contract entities associated with a plurality of user devices, wherein the past performance data at least comprises historical data associated with the contract entity for a predefined time period; determining, by the network-connected entity scoring computer, at least one firmographic data field, from a plurality of firmographic data fields, associated with the contract entity; retrieving, from the database by the network-connected entity scoring computer, customer management data associated with the contract entity; detecting, by the network-connected entity scoring computer, based on the firmographic data field, the customer management data, and the past performance data associated with the contract entity, a purchasing behavior associated with the contract entity; determining, by the network-connected entity scoring computer, a cohort comprising a subset of contract entities from the plurality of contract entities grouped therein, wherein the contract entity is grouped in the cohort based on the purchasing behavior detected for the contract entity; calculating, by the network-connected entity scoring computer, based at least on the grouping of the contract entity in the cohort, an impact score and a prospect score for the contract entity; and generating, by the network-connected entity scoring computer, an contract entity score for the contract entity based on the computed impact score and the computed prospect score.

According to an embodiment, the plurality of firmographic data fields may comprise commerce sectors, geolocation, and market segments.

According to an embodiment, the method may further comprise obtaining, by the network-connected entity scoring computer, feedback from the plurality of user devices, wherein the feedback is associated with an original impact score for the contract entity; determining, by the network-connected entity scoring computer, based on the obtained feedback, whether the original impact score for the contract entity is marked as accurate by a predefined percentage of user devices from the plurality of user devices; creating a neural network model.

According to an embodiment, the method may further comprise determining, by the network-connected entity scoring computer, based on the obtained feedback, whether the original impact score for the contract entity is marked as accurate by the predefined percentage of user devices from the plurality of user devices; determining, by the network-connected entity scoring computer, in response to a determination that the original impact score is marked as inaccurate, whether the current impact score is greater than the original impact score and the original impact score is lower than a first threshold; and associating, by the network-connected entity scoring computer, the current impact score with the contract entity, in response to a determination that the current impact score is greater than the original impact score and the original impact score is lower than the first threshold.

According to an embodiment, the method may further comprise adding, by the network-connected entity scoring computer, a second threshold to the original impact score, in response to a determination that the current impact score is not greater than the original impact score; and associating, by the network-connected entity scoring computer, the original impact score with the contract entity.

According to an embodiment, the method may further comprise determining, by the network-connected entity scoring computer, in response to the determination that the original impact score is marked as inaccurate, whether the current impact score is lower than the original impact score and the original impact score is greater than the first threshold; and associating, by the network-connected entity scoring computer, the current impact score with the contract entity, in response to a determination that the current impact score is lower than the original impact score and the original impact score is greater than the first threshold.

According to an embodiment, the method may further comprise subtracting, by the network-connected entity scoring computer, the second threshold from the original impact score, in response to a determination that the current impact score is not lower than the original impact score; and associating, by the network-connected entity scoring computer, the original impact score with the contract entity.

According to an embodiment, the method may further comprise associating, by the network-connected entity scoring computer, the original impact score with the contract entity, in response to a determination that the original impact score is not greater than the first threshold.

According to an embodiment, the method may further comprise generating, by the network-connected entity scoring computer, a ranking of the contract entity based on the contract entity score; determining, by the network-connected entity scoring computer, a quadrant, within an contract entity matrix, for the contract entity based on a comparison of the generated ranking for the contract entity to a predefined percentile threshold; positioning, by the network-connected entity scoring computer, the contract entity in the determined quadrant.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an exemplary system architecture for operating an entity scoring computer, according to a preferred embodiment of the invention.

FIG. 6 illustrates an exemplary method for creating an opportunity matrix, according to a preferred embodiment of the present invention.

FIG. 7A illustrates an exemplary method for creation of cohorts for grouping one or more contract entities based on firmographic data fields, according to a preferred embodiment of the present invention.

FIG. 7B illustrates an exemplary method for calculating strength scores for each contract entity grouped within a cohort, according to a preferred embodiment of the present invention.

FIG. 7C illustrates an exemplary method for ranking cohorts based on calculated cohort scores, according to a preferred embodiment of the present invention.

FIG. 8 illustrates an exemplary method for augmenting cohort scores based on recalculation of prospect scores, according to an embodiment of the present invention.

FIG. 9A illustrates an exemplary method for creating a training dataset for training local neural networks for generating impact scores and prospect scores, according to an embodiment of the present invention.

FIG. 9B illustrates an exemplary method for creation of local neural networks for prospect and impact score calculations, according to an embodiment of the present invention.

FIG. 10 illustrates an exemplary opportunity matrix, according to an embodiment of the present invention.

### DETAILED DESCRIPTION

The inventor has conceived, and reduced to practice, in a preferred embodiment of the invention, systems and methods for analyzing a plurality of customer relationship management (CRM) accounts and producing predictions of which accounts are most likely to yield a maximum account score for each user device of a plurality of user devices.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized, and that structural, logical, software, electrical, and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

Devices that are in communication with each other need not be in continuous communication with each other unless expressly specified otherwise. In addition, devices that are in communication with each other may communicate directly or indirectly through one or more communication means or intermediaries, logical or physical.

A description of an embodiment with several components in communication with each other does not imply that all such components are required. On the contrary, a variety of optional components may be described to illustrate a wide variety of possible embodiments of one or more of the inventions and in order to illustrate one or more aspects of the inventions more fully. Similarly, although process steps, method steps, algorithms or the like may be described in a sequential order, such processes, methods, and algorithms may generally be configured to work in alternate orders unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

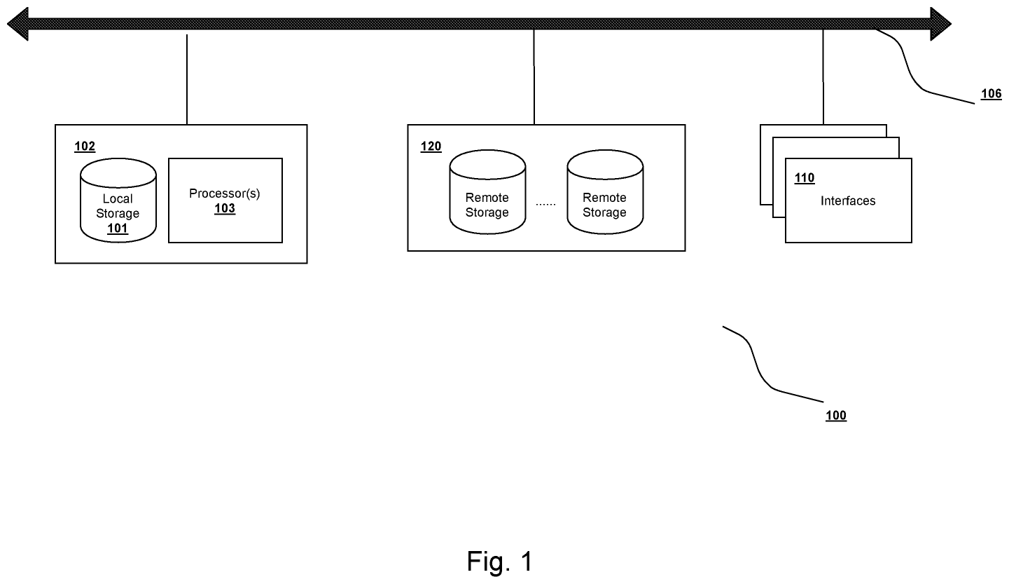

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random-access memory (RAM) and/or read-only memory (ROM), including, for example, one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may, for example, support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments, a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories, or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example, a Java™ compiler and may be executed using a Java virtual machine or equivalent, or files containing higher level code that may be executed by the computer using an interpreter (for example, scripts written in Python, Perl, Ruby, Groovy, or any other scripting language).

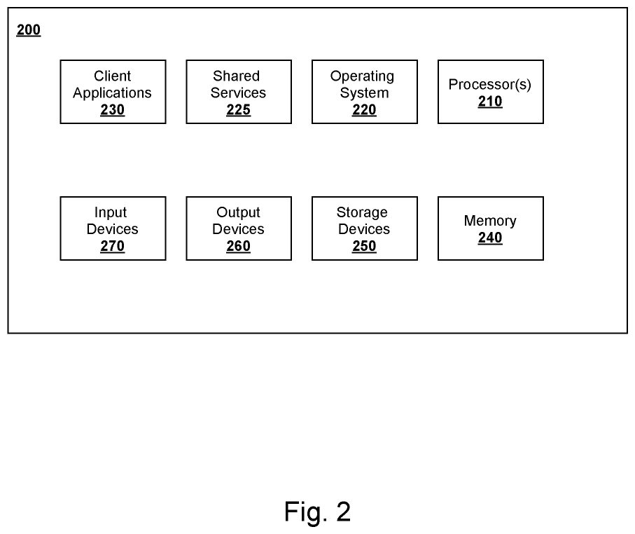

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as, for example, a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200 and may be useful for providing common services to client applications 230. Services 225 may, for example, be WINDOWS™ services, user-space common services in a Linux environment, or any other type of common service architecture used with operating system 210. Input devices 270 may be of any type suitable for receiving user input, including, for example, a keyboard, touchscreen, microphone (for example, for voice input), mouse, touchpad, trackball, or any combination thereof. Output devices 260 may be of any type suitable for providing output to one or more users, whether remote or local to system 200, and may include, for example, one or more screens for visual output, speakers, printers, or any combination thereof. Memory 240 may be random-access memory having any structure and architecture known in the art, for use by processors 210, for example, to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

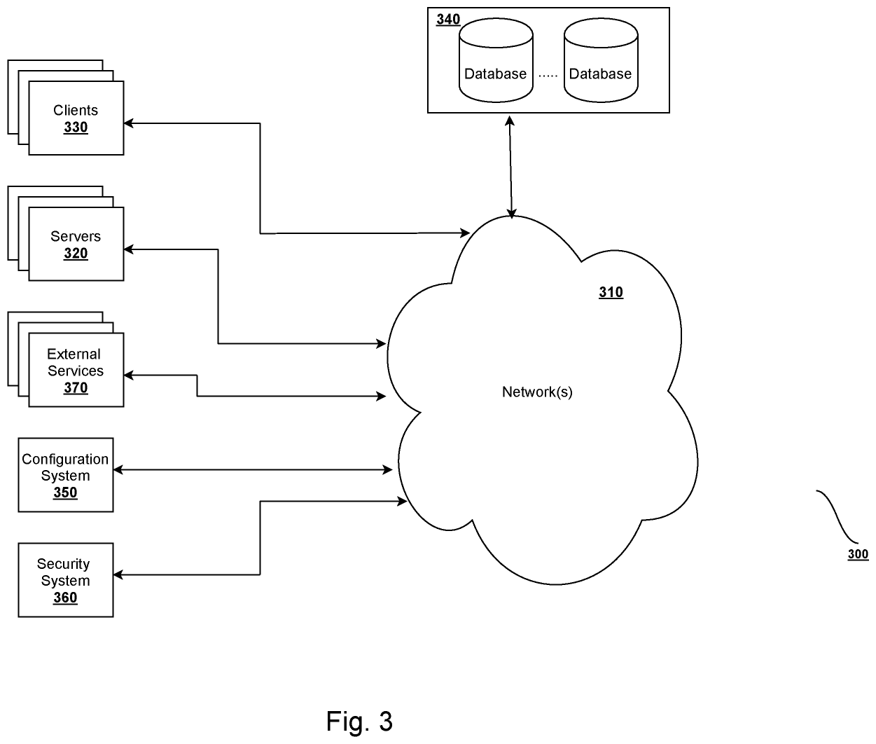

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 310 may be implemented using any known network protocols, including, for example, wired and/or wireless protocols.

In addition, in some embodiments, servers 320 may call external services 370 when needed to obtain additional information or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access, and manipulation means. For example, in various embodiments, one or more databases 340 may comprise a relational database system using a structured query language (SQL), while others may comprise an alternative data storage technology such as those referred to in the art as “NoSQL” (for example, Hadoop Cassandra, Google Bigtable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation unless a specific security 360 or configuration system 350 or approach is specifically required by the description of any specific embodiment.

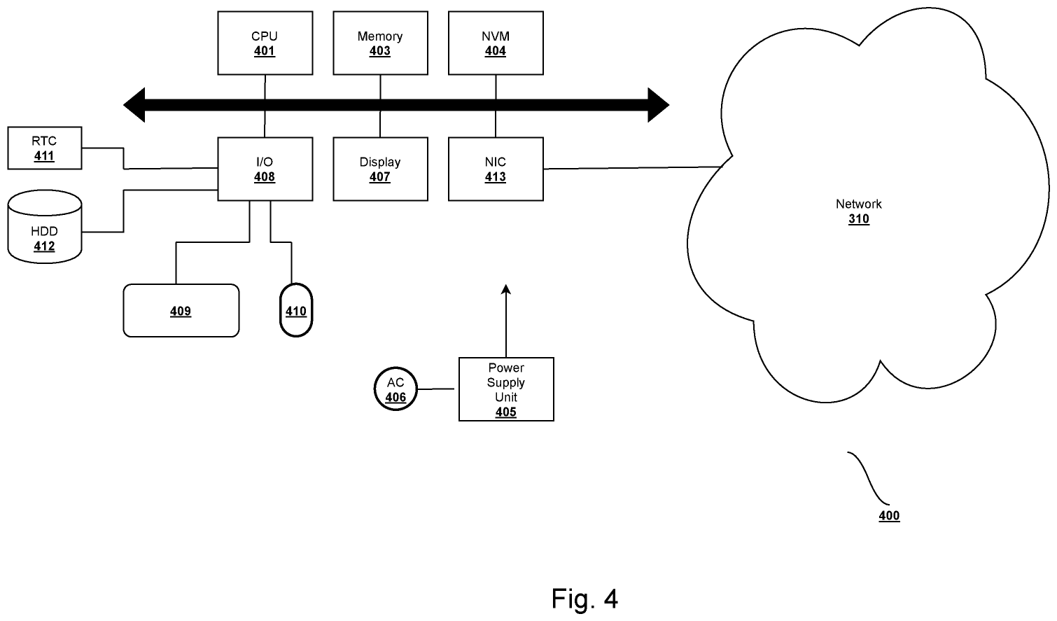

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

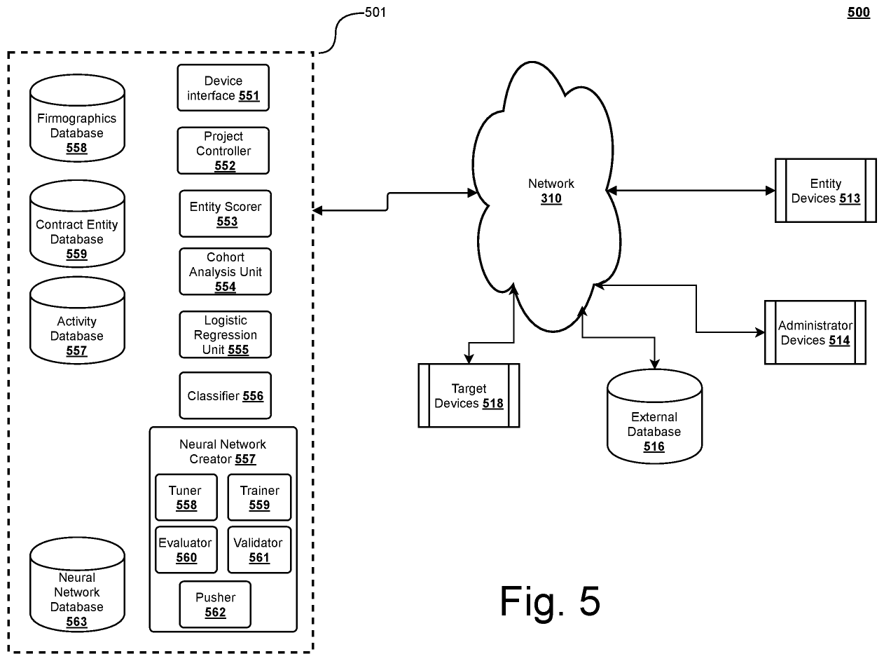

FIG. 5 is a block diagram of an exemplary system architecture 500 for operating entity scoring computer 501, according to a preferred embodiment of the invention. According to the embodiment, entity scoring computer 501, in communication with a plurality of entity devices 513, may comprise a plurality of programming instructions stored in a memory and operating on a processor of a network-connected computing device and may be configured to communicate via network 310 such as the Internet or other data communication network. For example, entity scoring computer 501 may be configured to communicate via a cloud-based protocol to receive interactions from a plurality of entity devices 513, such as to enable one or more users to interact with entity scoring computer 501 via a web browser, another software application, or a specially programmed user computer. For example, entity scoring computer 501 may utilize network 310 to communicate with an external database 516 via a local network connection such as a LAN operated by a user or an internal data network operating on entity device 513.

In some embodiments, entity scoring computer 501 may further comprise device interface 551; project controller 552; entity scorer 553 and contract entity database 559; cohort creation unit 554 and firmographic database 558; and logistic regression unit 555 and activity database 557. In an embodiment, device interface 551 may manage input/output communications to one or more of entity devices 513, administrator devices 514, or target devices 518, and in some embodiments, to external database 516, over network 310. Entity scoring computer 501 may further comprise of a neural network creator 557 and neural network database 563. The neural network creator 557 may further comprise tuner 558, trainer 559, evaluator 560, validator 561, and pusher 562.

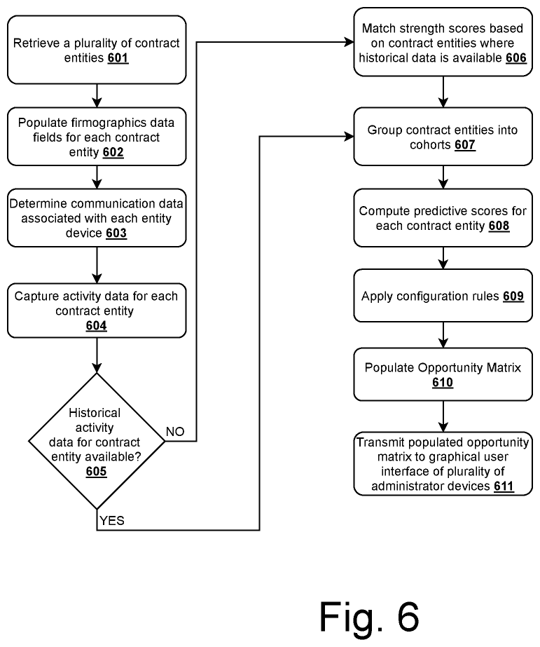

In a preferred embodiment, project controller 552 may be configured to analyze a plurality of variables associated with a plurality of target contract entities, associated with target devices 518 and a plurality of existing contract entities associated with entity devices 513 (herein jointly referred to as contract entities). Further, project controller 552 may perform methods disclosed herein to create a scoring algorithm to generate predictive scores for the contract entities, based on a grouping of the plurality of contract entities into one or more cohorts, as created by cohort creation unit 554 (as described in detail in FIG. 6).

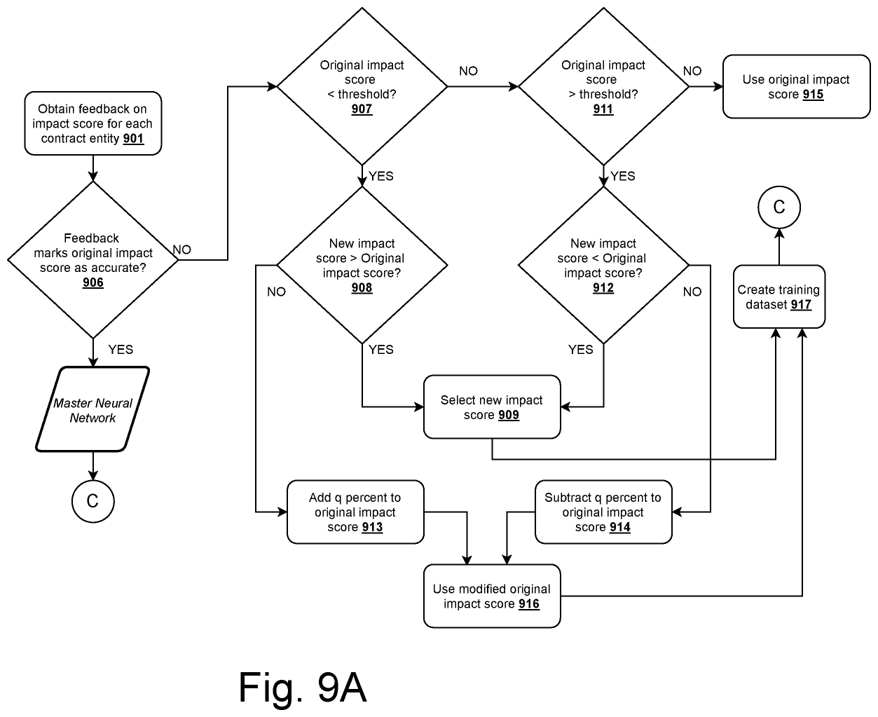

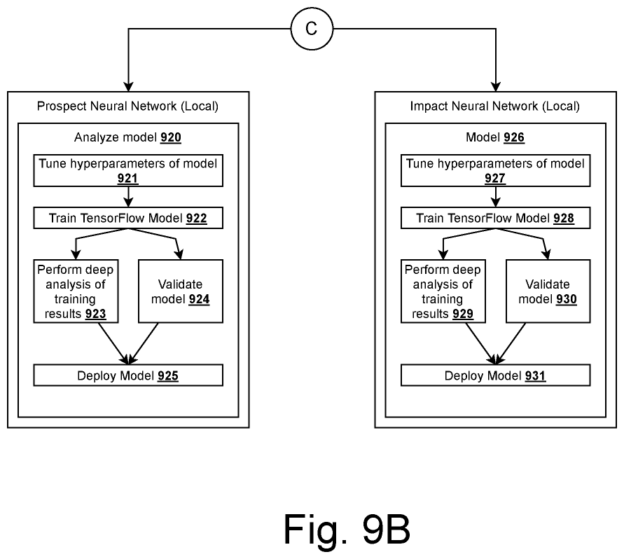

Further, within the computer architecture 500, entity scoring computer 501 may communicate with entity devices 513, administrator devices 514, and/or target devices 518 via network 310. Entity scoring computer 501, in several embodiments, may also include neural network creator 557 operable to create one or more neural networks based on feedback received on the scoring algorithm, from administrator devices 514 (as described in FIG. 9A), and the created one or more neural networks may be used by project controller 552 to create local neural networks (as described in detail in FIG. 9B).

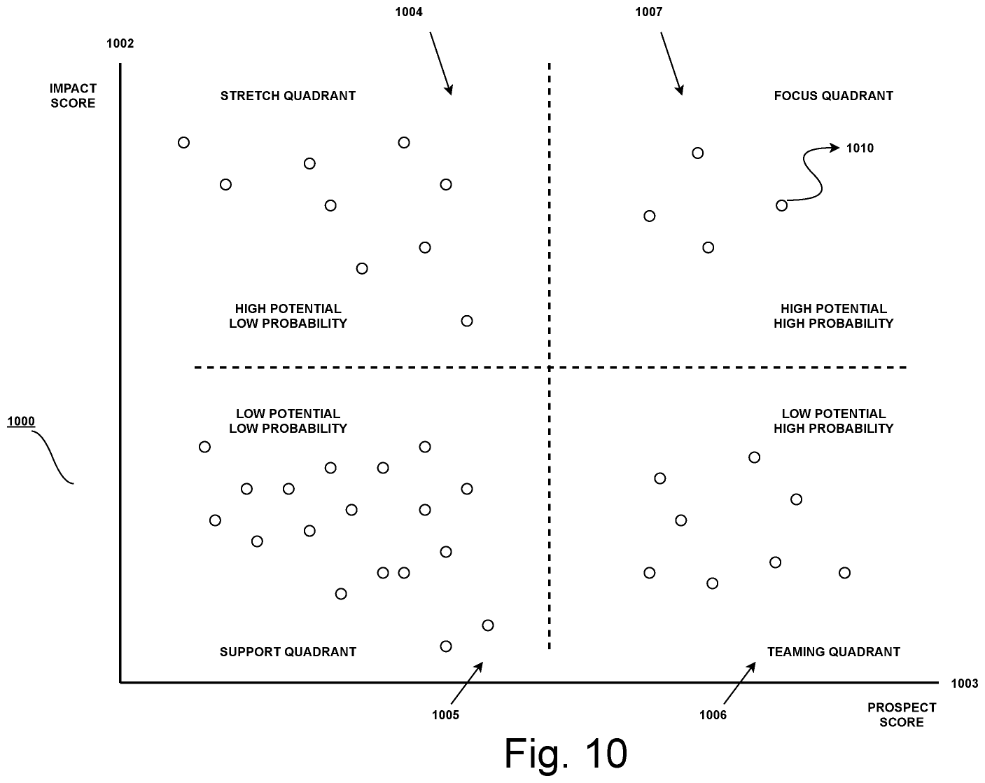

According to the embodiment, project controller 552 may generate the predictive scores, comprising of prospect scores and impact scores, for each contract entity. Prospect score may be indicative of a value of quantified propensity of a contract entity to be associated with a transaction. Impact score may relate to respective values of quantified potential (e.g., unit values) associated with such transactions for each contract entity. Based on the respective values of prospect scores and impact scores, entity scoring computer 501 may group each target contract entity into a cohort and create a matrix of contract entities recognizing strategic actions for processing transactions associated with the contract entities (described in further detail in FIG. 10).

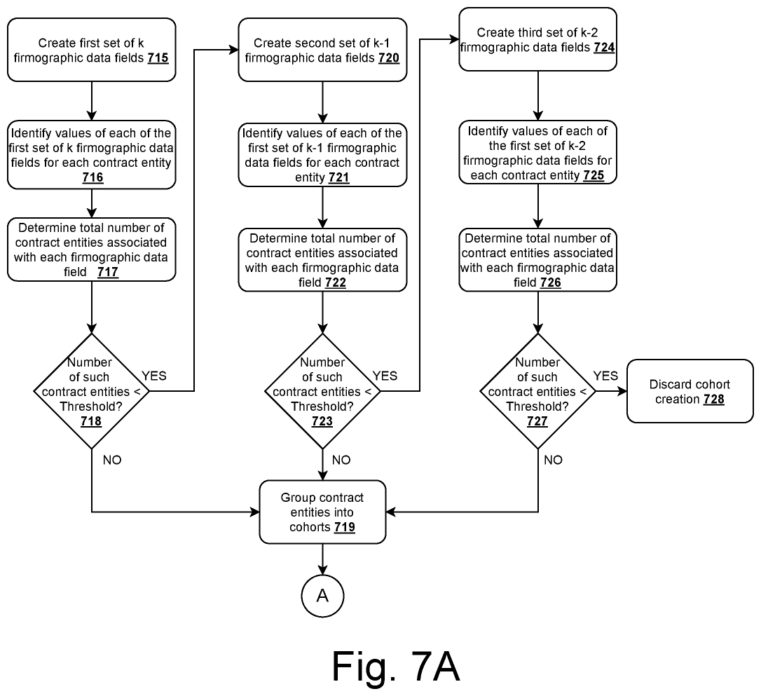

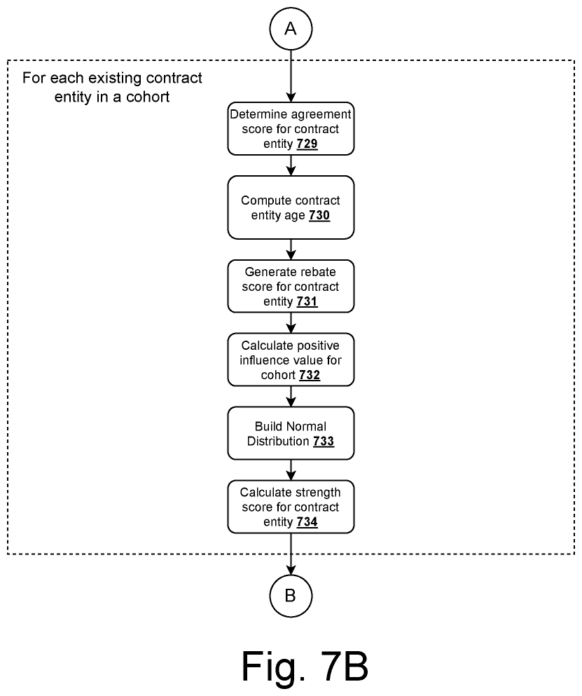

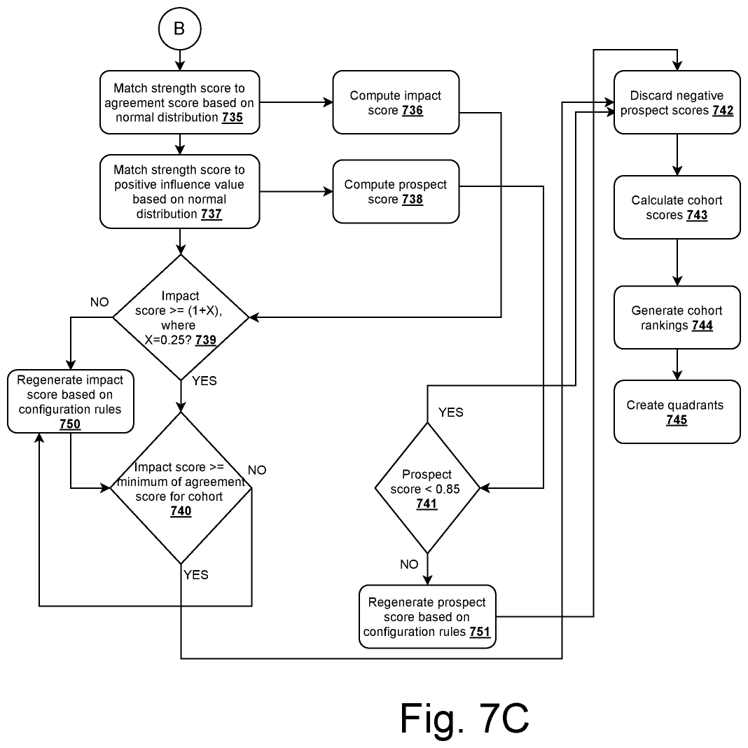

According to one embodiment, cohort creation unit 554 may analyze a first set of firmographic data fields for each of the plurality of contract entities to divide each contract entity into a cohort. According to the embodiment, the firmographic data fields may comprise variables including, but not limiting to, commerce sectors, geolocations, and market segments for one or more organizations associated with each of the plurality of contract entities. In another embodiment, creation of a cohort may further be augmented by analysis of a second set of firmographic data fields such as an annual revenue for an organization and/or a value of personnel count for the organization linked to the contract entity. Further, cohort creation unit 554 may generate the plurality of cohorts in a recursive manner, in that, a predetermined minimum threshold of target contract entities may always be grouped within each generated cohort (as described in FIG. 7A).

In case it is determined by cohort creation unit 554 that a total number of contract entities grouped in a cohort does not meet the predetermined minimum threshold, cohort creation unit 554 may group all contract entities within that cohort into a different cohort created by relaxing a grouping criteria by omission of one or more variables from the first set of firmographic data fields (e.g., a new broader cohort may comprise of analysis of commerce sector and market segment only, with, for example, the omission of geolocation from the first set of firmographic data fields). In an embodiment, details pertaining to the first and second set of firmographic data fields, such as commerce sectors, geolocations, market segments, revenues, employee count, etc., may be pre-generated by project controller 552 and stored in firmographics database 558. In several embodiments, other factors may be supplemented to the firmographic data fields by cohort creation unit 554, such as historic activity data associated with contract entities and communication data associated with entity devices 513 to generate said cohorts (described in FIG. 6).

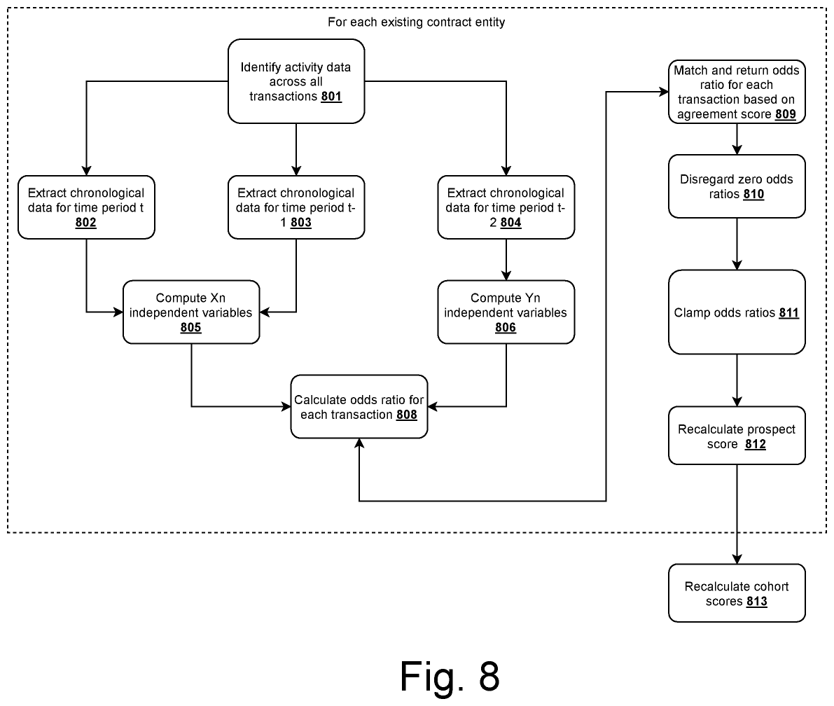

Further, in an embodiment, for each entity device 513, scorer 553 may recalculate predictive scores for a plurality of existing contract entities each linked to an entity device 513. According to the embodiment, predictive scores for the plurality of existing accounts may be recomputed by scorer 553 based on expansion and diversification actions analyzed for a predetermined period of time. In the embodiment, scorer 553, in order to recompute the predictive scores for existing contract entities, may analyze multiple chronological snapshots for the existing contract entities associated with each entity device 513. Based on the analysis, logistic regression unit 555 may perform binomial regression to compute one or more odds ratios, each representing a quantified likelihood of an outcome happening, e.g., further expansion and diversification actions associated with an existing contract entity. Further, scorer 553 may analyze the odds ratios to calculate a multiplier enhancement score or a reduction score indicative of how likely a given existing contract entity, having associated with a given transaction, is to be involved in further transactions. Based on the odds ratios, scorer 553 may recalculate the predictive scores for the existing contract entities, that may be used by scorer 553 to improve previously calculated predictive scores and therefore the cohort scores (as described in FIG. 8).

In a preferred embodiment, classifier 556 may obtain feedback crowdsourced from one or more entity devices 513, wherein such feedback may pertain to the generated predictive scores. Further, classifier 556 may use this feedback so as to create a training set to train and model a local neural network as well as create a master neural network (as described in FIG. 9A). In the embodiment, classifier 553 may categorize the obtained feedback into four categories including (a) predictive scores that are perceived as accurate; (b) predictive scores that should be increased in value; (c) predictive scores that should be decreased in value; and (d) predictive scores where no feedback is provided. Further, the output of the training dataset may then be used by neural network creator 557 to create local neural networks to enhance the scoring algorithms for both impact scores as well as prospect scores (as described in FIG. 9B). The master neural network and the local neural networks, in one embodiment, may be saved by neural network creator 557 in neural network database 563.

In an embodiment, entity scoring computer 501 may also provide a planning hub for administrator devices 514, including a graphical opportunity matrix, created by project controller 552 based on the predictive scores, the matrix comprising quadrants each recognizing varying action strategies for contract entities plotted thereon. The above entity scoring system 501 can advantageously synchronize tens of millions of records in a quick turnaround time, thereby arming CRM users, such as administrator devices 514 or other sales and business development devices, with actionable, live, and dynamic insights. Further, conventional entity scoring systems may only cater to a small set of accounts, whereas the entity scoring computer 501 of the present invention may advantageously provide strategies that may be appropriate for each contract entity of a larger number of contract entities, thus allowing administrator devices 516 to engage in improved marketing and sales capabilities for a large number of contract entities.

The aforementioned functions of entity scoring computer 501, along with other preferred embodiments of the present invention, are described in greater detail below, in conjunction with FIGS. 6-10.

### Detailed Description of Exemplary Embodiments

FIG. 6 illustrates an exemplary method for creating an opportunity matrix, according to a preferred embodiment of the present invention. In the embodiment, in a first step 601, project controller 552 may retrieve a plurality of contract entities. In the embodiment, project controller 552 may retrieve the plurality of contract entities from one or more of contract entity database 559 and external database 516. In an embodiment, the plurality of contract entities retrieved by project controller 552 may comprise of a plurality of target contract entities and a plurality of existing contract entities. In the embodiment, the plurality of target contract entities may comprise organizations, accounts, sales leads, and the like, identified as a target for sale of products and/or services by a given supplier. Further, the plurality of existing target entities may comprise of organizations, accounts, sales leads, and the like, identifying customers that have been sold at least one product and/or service by a given supplier. In one embodiment, each data field associated with contract entities, retrieved by project controller 552 from external database 516, may be stored by project controller 552 within the contract entity database 559.

In a next step 602, project controller 552 may populate firmographic data fields for each of the plurality of contract entities. In an embodiment, the firmographic data fields for a contract entity may be indicative of descriptive attributes for the contract entity, such that the firmographic data fields may be used by entity scoring computer 501 to aggregate the contract entity into one or more meaningful segments. In the embodiment, the firmographic fields may comprise of data fields, including but not limited to, commerce sector data, geolocations, market segment data, annual revenues, personnel count, etc. associated with each contract entity. Further, project controller 552 may populate the firmographic data fields for the plurality of contract entities using data extracted from data sources such as financial datastores, organizational websites, filing reports, third-party data providers, U.S. Securities and Exchange Commission's Electronic Data Gathering, Analysis and Retrieval (EDGAR) database, etc., as well as from previously stored data in firmographics database 558. In one embodiment, firmographic data fields populated by project controller 552 using data other than that previously stored in firmographics database 558, may be stored by project controller 552 in the firmographics database 558.

Referring again to FIG. 6, in a next step 603, project controller 552 may determine communication data associated with each entity device 513 and each target device 518. In an embodiment, each entity device 513 may be linked with at least one of the plurality of existing contract entities. In the embodiment, the communication data associated with an entity device 513 may be inclusive of email communications, telephonic communications, geolocation information, text communications, etc. recognizing transactional data associated with an existing contract entity linked to the entity device 513. In an embodiment, project controller 552 may process the communication data associated with the entity devices 513 by techniques such as text parsing, natural language processing, speech to text conversion, and the like, on data extracted from the entity devices 513. Based on the processing of communication data by project controller 552, each existing contract entity and associated entity device 513, may be linked to specific communication data, to be used by entity scoring computer 501 for the creation of opportunity matrix, as elaborated in the description that follows. Similarly, each target device 518 may be queried for communications data, including marketing email, sales pitches, and the like, recognizing communications initiated with a respective target contract entity. As shown in FIG. 5, such communications may be initiated by entity scoring computer 501 to one or more target devices 518, via network 310.

In a next step 604, project controller 552 may capture activity data associated with each contract entity. In an embodiment, project controller 552 may capture activity data associated with each contract entity, that may be indicative of information such as transactional data, entity age, expansion actions, diversification actions, rebate data, and the like for each contract entity. Further, in a next step 605, project controller 552 may determine whether historical activity data is associated with one or more entities from the plurality of contract entities. In an embodiment, based on the determination by project controller 552 that historical activity data is associated with one or more contract entities, each such contract entity may be identified as existing contract entity by project controller 552. In the embodiment, all remaining contract entities from the plurality of contract entities, that have not identified as existing contract entries by project controller 552, may be identified by project controller 552 as target contract entities.

Referring back to step 605, in response to a determination by project controller 552 that historical activity data is associated with one or more contract entities (i.e., existing contract entities), the method may continue to step 607. Otherwise, in a next step 606, for contract entities, from the plurality of contract entities, for which no historical activity data is available (i.e., target contract entities), in a next step 606, project controller 552 may match strength scores based on contract entities for which historical activity data is available (i.e., existing contract entities) as identified by project controller 552. In an embodiment, project controller 552 may calculate and match the strength scores based on a combination of firmographics data fields for such contract entities (as described in greater detail with FIGS. 7A-7C).

In step 607, cohort creation unit 554 may group the plurality of cohorts into one or more cohorts. In an embodiment, cohort creation unit 554 may create the cohorts based on firmographics data fields that may be analyzed by cohort creation unit 554, for each contract entity and each transaction associated with a given organization. For example, cohort creation unit 554 may analyze a contract entity for each transaction (e.g., sale of a product or service) associated with the contract entity using firmographic data fields such as geolocation, commerce sector, market segment, annual revenue, etc. for that contract entity. In one embodiment, wherein there are multiple such transactions associated with the contract entity, cohort creation unit 554 may create cohorts for each different transaction. That is, each contract entity may be grouped by cohort creation unit 554 into more than one cohort, and each such cohort may become part of a different opportunity matrix (as described in detail with respect to FIG. 10).

In a next step 608, logistic regression unit 555 may generate predictive scores for each contract entity grouped in a cohort-by-cohort creation unit 554. In an embodiment, predictive scores for each contract entity may at least comprise of an impact score and a prospect score. According to the embodiment, the impact score may be indicative of a potential of transaction for a given contract entity. For example, an impact score for a given contract entity may recognize a prediction of a dollar amount that the contract entity may spend on a selected transaction. Further, a probability score for target contract entities may be indicative of a propensity of that contract entity to activate a transaction (e.g., acquire a product and/or service).

In a next step 609, cohort creation unit 554 may apply configuration rules to the calculated predictive scores for each contract entity grouped in at least one cohort. In an embodiment, cohort creation unit 554 may apply the configuration rules to the calculated predictive scores to ensure that the predictive scores are included within a predetermined range of predictive scores as determined by project controller 552. For instance, one or more configuration rules may be applicable to both impact scores and prospect scores for a contract entity, such that the contract entity remains plottable within the opportunity matrix created by project controller 552. In another embodiment, cohort creation unit 554 may apply configuration rules to the predictive scores in a manner such that outlier values for such predictive scores may be disregarded during the scoring of the plurality of contract entities. The configuration rules, in some embodiments, may include rules indicating that all prospect scores must be greater than 0; all prospect scores must be lower than or equal to 0.85; all impact scores must be greater than or equal to 1.25 times a value of agreement score for all transactions; and the like. The configuration rules and their application to the scoring of contract entities are further described in detail with respect to FIG. 7C.

In a next step 610, project controller 552 may create one or more opportunity matrices based on the cohorts containing contract entities, as created by cohort creation unit 554. In an embodiment, each opportunity matrix may comprise of two different matrices juxtaposed with one another, as shown in FIG. 10. In the embodiment, the two different matrices may include an impact matrix and a prospect matrix. The impact matrix, in some embodiments, may be created by project controller 552 in a manner such that different contract entities may be plotted thereon as data points based on their respective impact scores. Further, the prospect matrix may be created by project controller 552 such that different contract entities may be plotted thereon as data points based on their respective prospect scores. Further, each opportunity matrix created by project controller 552 may comprise of four different quadrants, such that each quadrant may define action strategies

In some embodiments, an opportunity matrix may be created by project controller 552 for each different transaction. Further, such an opportunity matrix may advantageously provide insights on incremental untapped potential and a quantified propensity for activation of additional and new transactions by the plurality of contract entities. Further, the target contract entities may preferably be assigned predictive scores even with the absence of any historical activity data associated with them, thereby enabling detailed analysis of such target contract entities as part of a preemptive course of action.

Referring again to FIG. 6, in a next step 611, project controller 552 may transmit the populated opportunity matrix to a graphical user interface of one or more of administrator devices 514. In an embodiment, the opportunity matrix may be transmitted to the administrator devices 514 based on a request received from the administrator devices 514 and/or based on an ownership of a contract entity by one or more administrator devices 514. For example, each administrator device 514 may be linked to a contract entity for transactional activity associated with the contract entity. Based on such linkages between one or more contract entities and an administrator devices 514, project controller 552 may transmit one or more opportunity matrices, that contain said contract entities as data points, to graphical user interface of said administrator device 514.

FIGS. 7A-C illustrate an exemplary method for ranking a plurality of cohorts based on cohort scores, according to a preferred embodiment of the present invention.

According to an embodiment, FIG. 7A illustrates an exemplary method for creation of cohorts for grouping one or more contract entities based on firmographic data fields. In the embodiment, the method described herein may be used by entity scoring computer 501 to generate cohorts containing contract entities grouped therein, using firmographics data fields, by performing steps 715-727.

In a first step 715, project controller 552 may create a first set of k firmographic data fields. In an embodiment, project controller 552 may select k firmographic data fields from a plurality of data fields including but not limited to commerce sector, geolocation(s), market segment, personnel count, income information, affiliates, and the like, such that each of the k firmographic data fields are associated with a plurality of contract entities. In an embodiment, the value of k may be predetermined by project controller based on one or more factors, e.g., configuration rules. For the sake of brevity, in the description that follows, embodiments may be described assuming the value of k to be predetermined by, for example, 3. Further, the three firmographic data fields selected by project controller 552 may include commerce sector, geolocation, and market segment. A person skilled in the art would however appreciate that other values of k as well as other combination of firmographic data fields may be selected by project controller 552.

In a next step 716, project controller 552 may determine value for each of the k firmographic data fields, for each contract entity under consideration. In the embodiment described above, wherein k is predetermined to be 3 and the firmographic data fields include commerce sector, geolocation, and market segment, project controller 552 may determine, for each contract entity, a commerce sector in which an organization associated with the contract entity operates; geolocations associated with the organization; and information pertaining to market segment to which the organization may pertain.

Referring again to FIG. 7A, in a next step, 717, project controller 552 may determine number of contract entities having information with the k firmographic fields. In an embodiment, project controller 552 may determine a contract entity as having data for each firmographic data field when the contract entity may have associated data tabulated for each firmographic data field stored within firmographics database 558. For instance, referring again to the embodiment wherein the value of k is predetermined by project controller 552 to be 3, for each contract entity under consideration, project controller 552 may mine data associated to a commerce sector in which an organization associated with the contract entity operates; geolocations associated with the organization; and information pertaining to market segment to which the organization may pertain, either stored within firmographics database 558 and/or from one or more external databases, such as external database 516. In an embodiment, based on such data mining, in a next step 717, project controller 552 may determine a total number of contract entities for which each firmographic data field has associated data available for cohort creation.

Further, in a next step 718, project controller 552 may determine whether a total number of contract entities, having data available for each of the k firmographic data fields, is lower than a threshold. In response to a determination by project controller 552 that the total number of such contract entities is not lower than the threshold, the method may continue to step 719. Otherwise, in a next step 720, project controller 552 may create a second set of k−1 firmographic data fields. In an embodiment, project controller 552 may select the k−1 firmographic data fields again from the plurality of data fields described above, including but not limited to, commerce sector, geolocation(s), market segment, personnel count, income information, affiliates, and the like, such that each of the k−1 firmographic data fields are associated with a plurality of contract entities. In a preferred embodiment, project controller 552 may create the second set of k−1 firmographic data fields to ensure that contract entities that may not have data available for all k firmographic data fields, may again be processed for cohort creation. Such a recursive logic for cohort creation by entity scoring computer 501 may ensure that most of the contract entities under consideration may be successfully grouped into cohorts created by cohort creation unit 554, for further processing and plotting as data points onto the opportunity matrices.

For instance, referring again to the embodiment wherein the value of k is predetermined by project controller 552 to be 3, the second set of firmographic data fields may comprise of k−1, i.e., 2 firmographic data fields. In one embodiment, the two firmographic data fields may comprise of commerce sector and geolocation and market segment may be omitted as one of the firmographic data fields. That is, for each contract entity under consideration, in a next step 721, project controller 552 may mine data associated to a commerce sector in which an organization associated with the contract entity operates and geolocations associated with the organization, stored within firmographics database 558 and/or from one or more external databases, such as external database 516. In an embodiment, based on the mining of such data, in a next step 722, project controller 552 may determine a total number of contract entities for which each firmographic data field has associated data available for cohort creation.

Referring again to FIG. 7A, in a next step 723, project controller 552 may determine whether a total number of contract entities, having data available for each of the k−1 firmographic data fields, is lower than a threshold. In response to a determination by project controller 552 that the total number of such contract entities is not lower than the threshold, the method may continue to step 719. Otherwise, in a next step 724, project controller 552 may create a third set of k−2 firmographic data fields. In an embodiment, project controller 552 may select the k−2 firmographic data fields from the plurality of data fields described above, including but not limited to, commerce sector, geolocation(s), market segment, personnel count, income information, affiliates, and the like, such that each of the k−2 firmographic data fields are associated with a plurality of contract entities.

For instance, referring again to the embodiment wherein the value of k is predetermined by project controller 552 to be 3, the third set of firmographic data fields may comprise of k−2, i.e., a single firmographic data field. In one embodiment, the single firmographic data field may comprise of commerce sector such that geolocation and market segment data fields may be omitted as the remaining firmographic data fields. That is, for each contract entity under consideration, in a next step 721, project controller 552 may mine data associated to a commerce sector in which an organization associated with the contract entity operates, stored within firmographics database 558 and/or from one or more external databases, such as external database 516. In an embodiment, based on the data mining, in a next step 722, project controller 552 may determine a total number of contract entities for which the firmographic data field has associated data available for cohort creation.

Referring again to FIG. 7A, in a next step 723, project controller 552 may determine whether a total number of contract entities, having data available for each of the k−2 firmographic data fields, is lower than a threshold. In response to a determination by project controller 552 that the total number of such contract entities is not lower than the threshold, the method may continue to step 719 wherein cohort creation unit 554 may create a different cohorts for contract entities having data available for the first set of k firmographic data fields; contract entities having data available for the first set of k−1 firmographic data fields; and contract entities having data available for the first set of k−2 firmographic data fields. The method may then continue to FIG. 7B. Otherwise, in response to a determination, in step 726, by project controller 552 that the total number of contract entities having data available for k−2 firmographic data fields is lower than the threshold, in a next step 728, cohort creation unit 554 may discard creation of cohorts. In such a scenario, in one embodiment, project controller 552 may select a set of k firmographic data fields, different from the first set of k firmographic data fields, such that a predetermined number of contract entities may always be grouped into cohorts based on the processing of steps 715-728 by entity scoring computer 501.

Referring now to FIG. 7B, an exemplary method for calculating strength scores for each contract entity grouped within a cohort is disclosed, according to a preferred embodiment of the present invention. In the embodiment, various components of entity scoring computer 501 may perform steps 729-734 for each existing contract entity (i.e., target contract entities are omitted) grouped within a cohort (as described in the foregoing) to compute a strength score for said cohort. Further, the described exemplary method may be performed by entity scoring computer 501 for each cohort created by cohort creation unit 554.

In a first step 729, scorer 553 may compute an agreement score for an existing contract entity grouped within the cohort-by-cohort creation unit 554. In an embodiment, the agreement score may be indicative of a value of a transaction associated with the existing contract entity. For instance, in one embodiment, the agreement score for the existing contract entity may be indicative of a unit value of cumulative acquisitions (or agreement of acquisitions) of products and/or services by an organization linked to the existing contract entity. That is, the agreement score may be a total value of goods acquired by the organization, wherein the total value may be in units such as dollar, yen, dirham, etc. In an embodiment, wherein one or more agreement scores are calculated in different units, scorer 553 may consolidate such agreement scores to reflect a single standardized unit value, e.g., US Dollars. In an embodiment, an agreement score for the cohort may be determined by scorer 553 by computing a cumulative sum of all respective agreement scores for each existing cohort entity.

In a next step 730, scorer 553 may determine a contract entity age for the given existing contract entity grouped within the cohort. In an embodiment, the existing contract entity age may be determined by scorer 553 by computing a difference between a contract entity creation date (e.g., date of first agreement to acquire or date of registration of the contract entity with the entity scoring computer 501) and an agreement completion data for the existing contract entity (e.g., a date of completion of acquire of a product and/or service).

In a next step 731, scorer 553 may generate a rebate score for the given existing contract entity. In an embodiment, the rebate score for the existing contract entity may be determined based on one or more transactions associated with the existing contract entity. In the embodiment, wherein the transaction includes acquire of a product or service by an organization associated with the existing contract entity, the rebate score may be calculated by scorer 553 using the following exemplary sequence:

Rebate Score=quoted price−sale price

In the embodiment, the sale price associated with the transaction may be indicative of a final price at which the product or service has been acquired by the organization linked to the existing contract entity. Further, the quoted price may be the price initially quoted for the transaction, i.e., the initial price quoted for the sale of the product or service.

In a next step 732, scorer 553 may determine a positive influence value the cohort under consideration. In an embodiment, scorer 553 may calculate the positive influence value for the cohort, based on an identification of all existing contract entities within the cohort that have completed transactions associated with them. According to the embodiment, wherein the transactions include acquire of a product or service by the organizations associated with the existing contract entities, scorer 553 may identify all such acquisitions and generate a cumulative sum of identified acquisitions. Further, scorer may calculate positive influence value based on the following exemplary sequence:

$$Positive Influence Value = \frac{\begin{matrix}Cumulative sum of \\ identified acquisitions\end{matrix}}{Total number of contract entities}$$

In one embodiment, the positive influence value for the cohort may be indicative of a percentage of existing contract entities within the given cohort, that may have at least one transaction associated with them, wherein the transaction may comprise of a complete sale of a product or a service.

Referring again to FIG. 7B, in a next step 733, scorer 553 may build a normal distribution for the cohort. In an embodiment, scorer 553 may create the normal distribution for the cohort based on calculation of values of mean, median, standard deviation, maximum, and minimum values for the scores calculated by scorer 533 for the existing contract entities, as described in the foregoing. For instance, in one embodiment, the normal distribution may be built by score 553 using scores such as agreement scores, rebate scores, and positive influence scores, as calculated above for existing contract entities in the given cohort. In other embodiments, the normal distribution may be built by scorer 553 by combining one or more firmographic data fields available for target contract entities grouped within the cohort, in combination with the scores described in the foregoing. Such a normal distribution built by scorer 553 may ensure that each of the existing contract entities as well as each of the target contract entities are represented in the normal distribution to enable accurate scoring of the cohort.

In a next step 734, scorer 553 may calculate a strength score for the contract entity under consideration. In an embodiment, the strength score may be created for different scores, firmographic data fields, or a combination thereof, used by scorer 553 for the building of normal distribution. The calculation of strength score by scorer 553 may be based on the following exemplary sequence:

$$Strength Score = \frac{x - μ}{σ} ,$$

wherein, x denotes an observed value of the score, firmographic data field, or a combination thereof; μ denotes the mean of that observed value for the entire cohort; and σ denotes the standard deviation for the cohort, as calculated during the creation of the normal distribution by scorer 553.

Based on the calculations of strength scores, the agreement scores, the rebate scores, and the positive influence values, by score 553, entity scoring computer 501 may calculate the predictive scores (as described in detail with reference to FIG. 7C) for each contract entity, such that each contract entity may be plotted onto an opportunity matrix as a data point.

FIG. 7C illustrates an exemplary method for ranking cohorts based on calculated cohort scores, according to a preferred embodiment of the present invention. The predictive scores, in one embodiment, may include at least an impact score and a prospect score. In the embodiment, the predictive scores for a contract entity may be indicative of a predictive expansion and/or a diversification action associated with a transaction linked to the contract entity. For example, referring again to the embodiment wherein the transaction includes acquire of a product or service, an impact score may be indicative of a quantified potential (e.g., in terms of a unit value) of the organization related to the contract entity to acquire additional amounts of the same product or service (expansion action) or potential of the organization related to the contract entity to acquire new products or services (diversification action). Further, prospect score may be indicative of a quantified propensity (e.g., in percentage value) of the organization related to the contract entity for such expansion action and/or diversification action.

Referring now to FIG. 7C, in step 735, for a given cohort, cohort creation unit 554 may match one or more strength score calculated for the contract entity to the agreement score of a contract entity based on the normal distribution built by scorer 553. In an embodiment, matching of the strength score to the agreement score by cohort creation unit 554 may be performed to enable scorer 553 to compute, in step 736, the impact score for the given contract entity. In the embodiment, the matching may be performed by cohort creation unit 554 for at least one of two firmographic data fields associated with the contract entity comprising annual revenue and employee count. In several other embodiments, other firmographic data fields and combinations thereof may also be used.

In an embodiment, considering matching of the strength score with the agreement score by cohort creation unit 554 for “annual revenue” data field and/or the “employee count” data field, associated with the contract entity, the matching may comprise the following exemplary iterations:
identifying, by cohort creation unit 554, an absolute score for annual revenue calculated for the contract entity by scorer 553;
calculating, based on the normal distribution, by scorer 553, a mean value and a standard deviation value of agreement score for the cohort the contract entity is grouped within;
calculating, based on the normal distribution, by scorer 553, a mean value and a standard deviation value of employee count for the cohort the contract entity is grouped within;
determining, by scorer 553, strength scores for the contract entity each for annual revenue and employee count;
matching, by cohort creation unit 554, the strength score for annual revenue to mean value and standard deviation value of agreement score, to generate a first impact score; and
matching, by cohort creation unit 554, the strength score for employee count to mean value and standard deviation value of agreement score, to generate a second impact score.

In one embodiment, contract entity A may have an absolute score for annual revenue equaling, for example, 65 and an absolute score of employee count equaling, for example, 220. In the embodiment, a cohort in which contract entity A has been grouped into may have mean agreement score equaling 100, and a standard deviation value for agreement score equaling 20. Further, the cohort may have mean employee count score equaling 220, and standard deviation employee count equaling 50. In such a scenario, scorer 553 may calculate the strength score for annual revenue for the contract entity A to be 3 (mean plus two standard deviations, approximately) and a strength score for employee count to be 1 (mean). Further, cohort creation unit 554 may match the strength score for annual revenue to calculate the first impact score for contract entity A as following:

average (100)+2*standard deviations (2*20)=140.

Similarly, cohort creation unit 554 may match the strength score for employee count to calculate the second impact score for contract entity A to be equal to 100. The cohort creation unit 554, in some embodiments, may apply configuration rules to create a logic (described in detail below) for selecting the first impact score or the second impact score for contract entity A. Processing continues at step 739 (see below)

Referring again to FIG. 7C, in a next step 737, cohort creation unit 554 may match one or more strength scores for the contract entity, calculated by scorer 553, to the positive influence value calculated by scorer 553, to determine, in step 738, one or more prospect scores for the contract entity. In an embodiment, the prospect scores for the contract entity may include a first prospect score, computed by scorer 553, by matching the strength score to positive influence value for “annual revenue” data field. Similarly, the prospect scores for the contract entity may further include a second prospect score, computed by scorer 553, by matching the strength score to positive influence value for “employee count” data field. In one embodiment, the matching of the strength score to the positive influence value may be performed by cohort creation unit 554 based on the exemplary iterations described in the foregoing. In a next step 741, scorer 553 determines if prospect score is lower than or equal to 0.85, processing continues at step 742 (see below), otherwise scorer 553 may regenerate the impact score based on configuration rules.

In step, 739, project controller 552, may determine whether value of each impact score is greater than or equal to (1+X), wherein X may be predetermined to be, for example, 0.25. In several embodiments, other values of X may be predetermined as well. In response to a determination by project controller 552 that value of each impact score is not greater than or equal to (1+X), in a next step 750, scorer 553 may regenerate the impact score based on configuration rules. In one embodiment, wherein impact score is indicative of a quantified potential to acquire a product, the configuration rules may maintain that that the current value of quantified potential may be 100, any further values of impact score must be equal to or exceed 1.25. Based on the configuration rule, scorer 553 may regenerate the impact score whenever the calculated value of the impact score is less than 1.25.

However, in response to a determination by project controller 552 that the value of each impact score is greater than or equal to (1+X), in a next step 740, project controller 552 may further determine whether each calculated impact score is greater that or equal to a minimum value of agreement score for the cohort that the contract entity is a part of. In response to a determination by project controller 552 that value of each impact score is not greater than or equal to the minimum agreement score for the cohort the method may continue to step 750, wherein scorer 553 may regenerate the impact score based on configuration rules. Otherwise, in a next step 742, scorer 553 may discard every value of prospect scores that are negative. In a next step 743, scorer 554 may calculate the cohort scores for each cohort. The score may be calculated as:

Cohort Score=Impact Scores×Prospect Scores

In the above exemplary sequence, scorer 553 may calculate the cohort score by using impact scores and prospect scores calculated for each contract entity grouped within the cohort. Further, in a next step 744, cohort creation unit 554 may determine a rank for each cohort. In an embodiment, the rank for each cohort may be determined by cohort creation unit 554 generated based on the calculated cohort scores.

In a next step 745, project controller 552 may create a plurality of quadrants for an opportunity matrix that may be created to plot contract entities as data points. In an embodiment, the plurality of quadrants may be created by project controller 552 based on a predetermined percentile of impact scores as well as a predetermined percentile of prospect scores, given by “p.” In the embodiment, project controller 552 may predetermine the default value for p to be, for example, 75. In other embodiments, other values of p may be selected. The quadrants may be used by project controller 552, in a preferred embodiment, to plot the opportunity matrix, as described in FIG. 10.

FIG. 8 illustrates an exemplary method for augmenting prospect scores for existing contract entities based on activity data associated with existing contract entities, according to an embodiment of the present invention. According to the embodiment, in a first step 801, project controller 552 may identify historical activity data for each a contract entity across all transactions. In an embodiment, the historical activity data may comprise transactional data, entity age, agreement scores, expansion actions, diversification actions, rebate scores, positive value scores, and the like for the contract entity. In the embodiment, the historical activity data may be extracted by project controller 552 by querying the activity database 557 and/or contract entity database 559.

In a next step, 802, project controller 552 may extract chronological activity data, from the historical activity data, for a first predetermined time period t for the existing contract entity. Further, in a next step, 803, project controller 552 may extract chronological data for a second predetermined time period t−1 for the existing contract entity.

In a next step 805, logistic regression unit 555 may compute Xₙ variables, wherein n denotes a total number of all transactions. In an embodiment, logistic regression unit 555 may compute the Xₙ variables using the chronological activity data for the time periods t and t−1. In the embodiment, wherein the value of t is predetermined by project controller 552 to be, for example, 3 years, and the total number of transactions associated with the existing contract entity, i.e., n is 3, logistic regression unit 555 may compute the X₁, X₂, and X₃ variables in the form of binary values. For instance, referring again to the embodiment wherein the transaction comprises an acquisition of a product, if a total of three products have been acquired by the existing contract entity, logistic regression unit 555 may determine variable X₁ as 1 if product 1 has been acquired by the existing contract entity both 3 years ago as well as 2 years ago. Otherwise, logistic regression unit 555 may determine the value of X₁ as 0. Similarly, logistic regression unit 555 may determine variable X₂ as 1 if product 2 has been acquired by the existing contract entity both 3 years ago as well as 2 years ago. Otherwise, logistic regression unit 555 may determine the value of X₂ as 0. The value of X₃ may be similarly computed by logistic regression unit 555.

Referring again to FIG. 8, in a next step, 804, project controller 552 may extract chronological data for a third predetermined time period t−2 for the existing contract entity. Further, in a next step 806, logistic regression unit 555 may compute Y, variables based on the third predetermined time period t−2 (i.e., 1 year). For instance, referring again to the embodiment wherein the transaction comprises an acquisition of a product, if a total of three products have been acquired by the existing contract entity, logistic regression unit 555 may determine variable Y₁ as 1 if product 1 has been acquired by the existing contract entity 1 year ago. Otherwise, logistic regression unit 555 may determine the value of Y₂ as 0. Similarly, logistic regression unit 555 may determine variable Y₂ as 1 if product 2 has been acquired by the existing contract entity 1 year ago. Otherwise, logistic regression unit 555 may determine the value of Y₂ as 0. The value of Y₃ may be similarly computed by logistic regression unit 555.

In a next step, 808, logistic regression unit 555 may calculate odds ratios for the existing contract entity for each associated transaction. In an embodiment, odds ratios may be indicative of a quantified probability enhancement (or diminution) of a propensity of the existing contract entity to be associated with a transaction given the values of variables Xₙ and Yₙ. According to the embodiment, logistic regression unit 555 may calculate the odds ratio using a binomial regression function, an example of which is given by the exemplary sequence:

$$Odds Ratio = \frac{odds ( x + 1 )}{odds ( x )} = \frac{F ( x + 1 )}{1 - ( F ( x + 1 ) )} / ( \frac{F ( x )}{1 - f ( x )} )$$

In an embodiment, the above exemplary sequence for computing odds ratio may be used by logistic regression unit 555 to compute odds ratio for each different transaction associated with the existing contract entity under consideration. For example, referring again to the embodiment wherein the transaction includes an acquisition of a product, the odds ratio may be computed by logistic regression unit 555 for all different products. For instance, for a first existing contract entity, logistic regression unit 555 may determine whether purchased a first product was purchased three years ago or whether a second product was purchased three years ago and so on. In such a scenario, logistic regression unit 555 may assign a value of 0 or 1 to each of the Xₙ as well as Yₙ variables.

In a next step, 809, logistic regression unit 555 may match and return odds ratio for each transaction based on an agreement score associated with the existing contract entity. Referring again to the above example, logistic regression unit 555 may use the odds ratio matching with each of the Yₙ such that a prospect of the first contract entity acquiring more of a given product 6, would utilize the odds ratio associated with variable Y₆ as a multiplier for the prospect score.

In a next step 810, logistic regression unit 555 may expunge odds ratios having values equal to, for example, 0. Further, in a next step 811, logistic regression unit 555 may clamp the values of all generated odds ratios to a predetermined range. For instance, in one embodiment, the range may be predetermined by logistic regression unit 555 to be, for example, between 0.5 and 5. The predetermination of the range for the odds ratio may be predetermined by logistic regression unit 555 to ensure that the resultant prospect scores, having abnormally high values may be modified by a multiplier within the predetermined range of odds ratio, for example 0.5, to reduce value of a given prospect score by half. Similarly, a 5× multiplier may be used to modify prospect scores where the values are abnormally low (based on an exemplary sequence described below). In one embodiments, logistic regression unit 555 may determine the multiplier value from the range of odds ratio based on the one or more configuration rules.

In a next step 812, scorer 553 may recalculate the prospect score for the existing contract entity. In an embodiment, scorer 553 may recalculate the prospect score for the existing contract entity based on the matching of the odds ratio for each transaction associated with the existing contract entity. In an embodiment, the prospect scores may be recalculated by scorer 553 based on the following exemplary sequence:

Recalculated Propect Score=Original Prospect Score×Odds Ratios

In an embodiment, logistic regression unit 555 may again apply adjustments to the recalculated prospect scores based on one or more configuration rules, as described with respect to FIG. 7C. Further, in a next step 813, scorer 553 may augment the cohort scores based on the recalculated prospect scores for all existing contract entities.

FIGS. 9A-B illustrates an exemplary method for creating a training dataset for training a local neural network and building the local neural network for calculating predictive scores for contract entities, according to an embodiment of the present invention.

FIG. 9A illustrates an exemplary method for creating a training dataset for training local neural networks for generating impact scores and prospect scores, according to an embodiment of the present invention. In the embodiment, the method starts at step 901, wherein classifier 556 may obtain feedback on impact scores calculated by scorer 553 for one or more contract entities, from one or more administrator devices 514.

In a next step 906, classifier 557 may determine whether obtained feedback is indicative of a predefined percentage of administrator devices 514 have recognized an original impact score as accurate. In an embodiment, the one or more of administrator devices 514 may be provided an option by project controller 552 to record an impact score as accurate or inaccurate. Further for inaccurate impact scores, administrator devices 514 may further record how the scores compare with a predetermined threshold. This information may be obtained by project controller 552 from each administrator device 514.

Referring again to FIG. 9A, in response to a determination by project controller 552 that the original impact score is recorded as accurate by administrator device 514, classifier 556 may loop the feedback into a master neural network. In an embodiment, the master neural network may be used by classifier 556 to generate the local neural network based on the method described in FIG. 9B.

However, in case it is determined, by project controller 552, that the original impact score is recorded as inaccurate by administrator device 514, in a next step 907, project controller 552 may determine whether the original impact score is lower than a predetermined threshold. In an embodiment, the threshold may be predetermined by project controller 552 based on, for example, configuration rules.

In response to a determination, by project controller 552, that the original impact score is lower than the threshold, in a next step 908, project controller 552 may determine whether a new impact score, computed based on the f number of fields, is greater in value than the original impact score. In response to a determination, by project controller 552, that the new impact score is greater than the original impact score in value, in a next step 909, scorer 553 may change the impact score for the contract entity to the new impact score. Otherwise, in a next step, 913, scorer 553 may add a “q” percent to the original impact score to generate a modified original impact score. Further, in a next step 916 scorer 553 may change the impact score for the contract entity to the modified original impact score.

Referring again to step 907, if it is determined by project controller 552 that the original impact score is not lower than the threshold, in a next step 911, project controller 552 may determine whether the original impact score is greater than the threshold. In case it is determined, by project controller 552, that the original impact score is not greater than the new impact score, in a next step 915, cohort creation unit 554 may use the original impact score for cohort analysis.

Otherwise, in a next step 912, project controller 552 may further determine whether the new impact score, computed based on the f number of fields, is lower in value than the original impact score. In case it is determined by project controller 552 that the new impact score is lower than the original impact score in value, in a next step, 909, scorer 553 may associated the new impact score with the contract entity. Otherwise, in a next step 914, the “q” percent may be subtracted from the original impact score to create a modified original impact score. In an embodiment, the value of q may be predetermined by project controller 552 to 20.

Again, in step 916, scorer 553 may change the impact score for the contract entity to the modified original impact score. Further, based on the modifications in the original impact scores and calculation of the new impact scores, in a next step 917, classifier 556 may create a training model. The method may then continue to FIG. 9B.

Further, in a preferred embodiment, classifier 556 may train a recursive model based on new impact scores computed based on the above exemplary method. Such a recursive model may be advantageous in that improved impact scores may be created for analysis of contract entities. Further, sales and marketing professionals using the systems and methods described herein may utilize such feedback mechanisms to produce more accurate analysis of contract entities owing to the unique exemplary methods described herein, merging human judgement and analytical insights.

FIG. 9B illustrates an exemplary method for creation of local neural networks for prospect and impact score calculations, according to an embodiment of the present invention.

The methods described herein may be administered by neural network creator 557 to create the local neural network based on feedback received from one or more administrative devices 514, as well as based on the master neural network, as described above with respect to FIG. 9A. Further, the neural network creator 557 may create a prospect neural network as well as an impact neural network using methods described in the description that follows.

The method may begin at step 920, wherein trainer 559 may analyze the training model, as created by classifier 553, described in step 917. In an embodiment, analysis of the training model may include steps 921-925 of the disclosed method.

In step 921, tuner 558 may tune hyperparameters of the model. In an embodiment, the hyperparameters may include feedback received by project controller 502 for the impact scores associated with the contract entities, from one or more administrator devices 514.

In step 922, trainer 559 may train TensorFlow™ Model. In an embodiment, the Tensorflow™ model may comprise a function with learnable parameters, e.g., feedback received on the prospect scores, such that the model may map an input to an output. The optimal parameters, in an example, may be obtained by re-training the model on data, such that by feeding the model with newer feedback received on the prospect scores from administrator devices 516. Referring to a conventional model, i.e., TensorFlow.js there may be two ways to create a machine learning model, as described below:

using Layers API to build the model using layers; and/or

using Core API with lower-level ops such as tf.matMul( ) tf.add( ) etc.

In step 923, evaluator 560 may perform deep analysis of the training results. In an embodiment, the deep analysis may include performing data analysis, textual analysis, discourse analysis, and/or any combination of the aforementioned conventional techniques for deep analysis.

In step 924, validator 561 may validate the model.

In step 925, pusher 652 may deploy the model. In an embodiment, once pusher 652 deploys the model for prospect neural network, the model may learn based on continuous feedback from one or more administrator device 516, as well as based on inputs from the master neural network, described in FIG. 9A.

Further, neural network creator 557 may also create a similar impact neural network model 926 using feedback received for the impact scores by one or more administrator devices 516, by executing instructions such as those described in steps 927-931. In an embodiment, neural network creator 557 may create the impact neural network model 926 using a similar TensorFlow™ model as described for the creation of prospect neural network model 920.

In a preferred embodiment, creation of local neural networks, such as the prospect neural network model 920 and impact neural network model 926 may enable entity scoring computer 501 to automate and scale the entity scoring methods described herein by enabling a learning mechanism for the local neural networks that facilitates the use of feedback to improve accuracy of the generated impact scores and prospect scores (thereby improving the precision of the generated cohorts) without manual intervention or errors.

FIG. 10 illustrates an exemplary opportunity matrix, according to an embodiment of the present invention. According to the embodiment, project controller 552 may create an opportunity matrix 1000 with an x-axis 1003 denoting prospect score and a y-axis 1002 denoting impact score, as depicted in FIG. 10, using the impact scores and prospect scores calculated for each contract entity by scorer 553. In an embodiment, each quadrant may be indicative of and recognize one or more strategic actions to be undertaken by one or more administrator device 514 owners to yield profitable and scalable results.

In one embodiment, the opportunity matrix 1000 may be divided into four quadrants, i.e., stretch quadrant 1004, support quadrant 1005, teaming quadrant 1006, and focus quadrant 1007. In the embodiment, project controller 552 may determine one or more contract entities 1010 having high impact scores and low prospect scores, amongst all contract entities, and plot these contract entities into the stretch quadrant 1004. The contract entities 1010 plotted within the stretch quadrant 1004, by project controller 552, may include contract entities where further investigation and consultation with management may be required such that these contract entities 1010 may be pursued opportunistically. The contract entities plotted herein may comprise, in one embodiment, target accounts that may have a low likelihood of converting into customer accounts. However, if converted into customer accounts, these target accounts may have a high yield of profitability.

In another embodiment, project controller 552 may plot one or more contract entities 1010 into the support quadrant 1005 for contract entities having lower impact scores and lower prospect scores amongst all contract entities. In the embodiment, contract entities 1010 determined to have requirements of support from one or more partners and/or channel managers within an organization may be plotted within the support quadrant 1005. In one embodiment, contract entities 1010 to be placed in the support quadrant 1005 may be identified by project controller 552 by a comparison of respective percentile of impact scores and prospect scores of the contract entities, with the percentile value “p,”. In an embodiment, the value of p may be predetermined by project controller 552 to be, for example, 75. In the embodiment, all contract entities having percentile of impact scores and prospect scores lesser than equal to “p”, may be placed in the support quadrant 1005. In another embodiment, wherein contract entities represent customer accounts, the support quadrant 1005 may recognize opportunities to leverage partners to effectively and efficiently initiate transactions to the customer accounts plotted therein.

In yet another embodiment, project controller 552 may place one or more contract entities 1010, having lower impact scores but higher prospect scores amongst all contract entities, in the teaming quadrant 1006. In an embodiment, contract entities 1010 plotted within the teaming quadrant 1006, by project controller 552, may include contract entities 1010 where more team members may have to be assigned for such contract entities 1010 to identify one or more measures required to move these contract entities away from the teaming quadrant 1006. Contract entities plotted herein may have a smaller agreement score associated with them.

In one embodiment, project controller 552 may further plot one or more contract entities 1010 into the focus quadrant 1007. In the embodiment, the contract entities 1010 having impact scores and prospect scores greater than p may be placed in the focus quadrant 1007 by project controller 552. In an embodiment, the contract entities 1010 placed within the focus quadrant 1007 may include contract entities that may require most of the organization's resources since the probability of initiating transactions these contract entities may be the highest of all contract entities 1010.

In a preferred embodiment, the quadrants, as described above, may be created by project controller 552 by dividing the opportunity matrix using the percentile value p, as described. In the embodiment, the impact and prospect scores of each contract entity may be compared to the percentile value by project controller 552 in order to accurately demarcate between contract entities that are grouped into each quadrant.

The skilled person will be aware of a range of possible modifications of the various embodiments described above. Accordingly, the present invention is defined by the claims and their equivalents.

1. A system to generate and display data points based on one or more predictive scores, each data point identifying a contract entity, the system comprising:
a network-connected entity scoring computer comprising a memory, a processor, and a plurality of programming instructions, the plurality of programming instructions when executed by the processor cause the processor to:
obtain, from a database, past performance data associated with a contract entity from the plurality of contract entity, associated with a network-connected user device of a plurality of user devices, wherein the past performance data at least comprises historical data associated with the contract entity for a predefined time period;
determine at least one firmographic data field, from a plurality of firmographic data fields, associated with the contract entity;
retrieve, from the database, customer management data associated with the contract entity;
detect, based on the firmographic data field, the customer management data, and the past performance data associated with the customer, a purchasing behavior associated with the contract entity;
determine, a cohort to place the contract entity in, wherein the contract entity is placed within the cohort based on the purchasing behavior detected for the contract entity, and wherein each cohort comprises a subset of contract entities from the plurality of contract entities grouped therein;
calculate an original impact score and an original prospect score for the contract entity;
obtain feedback from the plurality of user devices, wherein the feedback is associated with the original impact score for the contract entity;
determine, based on the obtained feedback, whether the original impact score for the contract entity is marked as accurate or inaccurate by a predefined percentage of user devices of the plurality of user devices;
in response to a determination that the obtained feedback marks the original impact score as accurate, train a neural network model using the obtained feedback;
augment the impact score to generate a modified impact score using the trained neural network model;
in response to a determination that the original impact score is marked as inaccurate, determine whether a current impact score, as received from the predefined percentage of user devices, is greater than the original impact score and whether the original impact score is lower than a first threshold;
associate the current impact score with the contract entity when the current impact score is greater than the original impact score and the original impact score is lower than the first threshold;
calculate a cohort score for the cohort based on one of the current impact score, the modified impact score, or the original impact score, and the original prospect score, associated with each contract entity grouped within the cohort;
generate plottable data points, each identifying a contract entity within the cohort, based at least on the cohort score;
plot the generated data points on to a quadrant within a contract entity matrix; and
transmit the contract entity matrix to be displayed on a graphical user interface of an administrator device and/or one or more of the plurality of user devices.

2. The system of claim 1, wherein the programming instructions, when further executed by the processor, cause the processor to determine the at least one firmographic data field from the plurality of firmographic data fields comprising commerce sectors, geolocations, and market segments.

3-4. (canceled)

5. The system of claim 1, wherein the programming instructions, when further executed by the processor, cause the processor to:
add a second threshold to the original impact score, in response to a determination that the current impact score is not greater than the original impact score; and
associate the original impact score with the contract entity.

6. The system of claim 1, wherein the programming instructions, when further executed by the processor, cause the processor to:
determine, in response to the determination that the original impact score is marked as inaccurate, whether the current impact score is lower than the original impact score and the original impact score is greater than the first threshold; and
associate the current impact score with the contract entity in response to a determination that the current impact score is lower than the original impact score and the original impact score is greater than the first threshold.

7. The system of claim 6, wherein the programming instructions, when further executed by the processor, cause the processor to:
subtract the second threshold from the original impact score, in response to a determination that the current impact score is not lower than the original impact score; and
associate the original impact score with the contract entity.

8. The system of claim 6, wherein the programming instructions, when further executed by the processor, cause the processor to associate the original impact score with the contract entity in response to a determination that the original impact score is not greater than the first threshold.

9. The system of claim 1, wherein the programming instructions, when further executed by the processor, cause the processor to:
generate a ranking of the cohort based on the cohort score;
determine the quadrant, within the contract entity matrix, for the cohort based on a comparison of the generated ranking for the cohort to a predefined percentile threshold; and
position the contract entity in the quadrant.

10. A computer-implemented method for generating and displaying data points based on one or more predictive scores, each data point identifying a contract entity, the method comprising:
obtaining, from a database by a network-connected entity scoring computer, past performance data associated to a contract entity from the plurality of contract entities associated with a plurality of user devices, wherein the past performance data at least comprises historical data associated with the contract entity for a predefined time period;
determining, by the network-connected entity scoring computer, at least one firmographic data field, from a plurality of firmographic data fields, associated with the contract entity;
retrieving, from the database by the network-connected entity scoring computer, customer management data associated with the contract entity;
detecting, by the network-connected entity scoring computer, based on the firmographic data field, the customer management data, and the past performance data associated with the contract entity, a purchasing behavior associated with the contract entity;
determining, by the network-connected entity scoring computer, a cohort to place the contract entity in, wherein the contract entity is placed in the cohort based on the purchasing behavior detected for the contract entity, and wherein each cohort comprises a subset of contract entities from the plurality of contract entities grouped therein;
calculating, by the network-connected entity scoring computer, an original impact score and an original prospect score for the contract entity;
obtaining, by the network-connected entity scoring computer, feedback from the plurality of user devices, wherein the feedback is associated with the original impact score for the contract entity;
determining, by the network-connected entity scoring computer, based on the obtained feedback, whether the original impact score for the contract entity is marked as accurate or inaccurate by a predefined percentage of user devices of the plurality of user devices;
in response to determining that the obtained feedback marks the original impact score as accurate, training, by the network-connected entity scoring computer, a neural network model using the obtained feedback;
augmenting, by the network-connected entity scoring computer, the impact score to generate a modified impact score using the trained neural network model;
in response to determining that the original impact score is marked as inaccurate, determining, by the network-connected entity scoring computer, whether a current impact score, as received from the predefined percentage of user devices, is greater than the original impact score and whether the original impact score is lower than a first threshold;
associating, by the network-connected entity scoring computer, the current impact score with the contract entity when the current impact score is greater than the original impact score and the original impact score is lower than the first threshold;
calculating, by the network-connected entity scoring computer, a cohort score for the cohort based on one of the current impact score, the modified impact score, or the original impact score, and the original prospect score, associated with each contract entity grouped within the cohort;
generating, by the network-connected entity scoring computer, plottable data points, each identifying a contract entity within the cohort, based at least on the cohort score;
plotting, by the network-connected entity scoring computer, the generated data points on to a quadrant within a contract entity matrix; and
transmitting, by the network-connected entity scoring computer, the contract entity matrix to be displayed on a graphical user interface of an administrator device and/or one or more of the plurality of user devices;.

11. The method of claim 10, wherein the plurality of firmographic data fields comprises commerce sector, geolocation, and market segments.

12.-13. (canceled)

14. The method of claim 10, further comprising:
adding, by the network-connected entity scoring computer, a second threshold to the original impact score, in response to a determination that the current impact score is not greater than the original impact score; and
associating, by the network-connected entity scoring computer, the original impact score with the contract entity.

15. The method of claim 10, further comprising:
determining, by the network-connected entity scoring computer, in response to the determination that the original impact score is marked as inaccurate, whether the current impact score is lower than the original impact score and the original impact score is greater than the first threshold; and
associating, by the network-connected entity scoring computer, the current impact score with the contract entity, in response to a determination that the current impact score is lower than the original impact score and the original impact score is greater than the first threshold.

16. The method of claim 15, further comprising:
subtracting, by the network-connected entity scoring computer, the second threshold from the original impact score, in response to a determination that the current impact score is not lower than the original impact score; and
associating, by the network-connected entity scoring computer, the original impact score with the contract entity.

17. The method of claim 15, further comprising:
associating, by the network-connected entity scoring computer, the original impact score with the contract entity, in response to a determination that the original impact score is not greater than the first threshold.

18. The method of claim 10, further comprising:
generating, by the network-connected entity scoring computer, a ranking of the contract entity based on the cohort score;
determining, by the network-connected entity scoring computer, the quadrant, within the contract entity matrix, for the cohort, based on a comparison of the generated ranking for the cohort to a predefined percentile threshold; and
positioning, by the network-connected entity scoring computer, the cohort in the quadrant.
